(19) United States
(12) Patent Application Publication
(10) Pub. No.: US 2015/0303472 A1
(43) Pub. Date: Oct. 22, 2015

(54) POSITIVE ELECTRODE ACTIVE MATERIAL, AND POSITIVE ELECTRODE AND NON-AQUEOUS ELECTROLYTE SECONDARY BATTERY

(71) Applicant: SHARP KABUSHIKI KAISHA, Osaka-shi, Osaka (JP)

(72) Inventors: Tomohisa YOSHIE, Osaka-shi (JP); Yuichi KAMIMURA, Osaka-shi (JP); Koji OHIRA, Osaka-shi (JP); Motoaki NISHIJIMA, Osaka-shi (JP)

(73) Assignee: SHARP KABUSHIKI KAISHA, Osaka-shi, Osaka (JP)

(21) Appl. No.: 14/437,869

(22) PCT Filed: Oct. 10, 2013
(86) PCT No.: PCT/JP2013/077606

§ 371 Date: Apr. 23, 2015

(30) Foreign Application Priority Data
Oct. 31, 2012 (JP) 2012-240908

(51) Int. Cl. H01M 4/58; C01B 25/45; H01M 10/052

(52) U.S. Cl. CPC H01M 4/5825; H01M 10/052; C01B 25/45; H01M 2004/028

(57) ABSTRACT

The positive electrode active material of the present invention contains an lithium iron phosphate compound having such diffraction peaks that diffraction peak intensity ratios at 2θ=17.2±0.5°, 2θ=20.8±0.5° and 2θ=25.6±0.5° are from 29 to 37, from 70 to 80 and from 85 to 94, respectively, when the diffraction peak intensity at 2θ=35.6±0.5° is deemed as 100 in a powder X-ray diffractometry using Cu-Kα ray as a radiation source. It becomes possible to provide a positive electrode active material that provides higher rate property and discharge capacity, and a positive electrode and a non-aqueous electrolyte secondary battery using the positive electrode active material.

### TECHNICAL FIELD

The present invention relates to a positive electrode active material, and to a positive electrode and a non-aqueous electrolyte secondary battery.

### BACKGROUND ART

Lithium secondary batteries have been put into practical use as non-aqueous electrolyte secondary batteries, and are in widespread use. Furthermore, in recent years, lithium secondary batteries have gained attention as not only as small size lithium secondary batteries for portable electronic devices, but also as devices for in-car use, or large capacity devices for electrical power storage for solar light power generation systems and for night-time electrical power storage. Therefore, higher safeness, costs and lifetimes are demanded.

Generally, layered transition metal oxides as represented by lithium cobaltate (LiCoO₂) are used as positive electrode active materials. However, layered transition metal oxides easily cause oxygen detachment at relatively low temperatures of around 150° C. in a full-charged state, and a thermal runaway reaction of a battery may occur due to the oxygen detachment. Accordingly, in the cases when a battery having such positive electrode active material is used in a portable electronic device, accidents such as heat generation and ignition of the battery may occur.

Therefore, a lithium-containing composite oxide having an olivine-type structure, which has a stable structure and does not deoxidize under an abnormal state, and thus is safer than LiCoO₂, such as lithium iron phosphate (LiFePO₄), is expected. Since lithium iron phosphate does not contain cobalt, which has a low crustal abundance, lithium iron phosphate has an advantage that it is relatively inexpensive. Furthermore, lithium iron phosphate also has an advantage that it is more stable in structure than layered transition metal oxides.

However, since the lithium iron phosphate itself has a low electroconductivity, when it is used as an active material, there is a problem that an electrical current cannot be sufficiently extracted. In response to this, as a method for imparting electroconductivity to lithium iron phosphate, for example, a method including imparting electroconductivity to the inside and surface of lithium iron phosphate particles by producing lithium iron phosphate containing carbon by calcining by a solid phase process, and further using a two-step thermal process by which carbon is precipitated by a thermal CVD process on the surfaces of the obtained lithium iron phosphate particles, has been suggested (Patent Literature 1).

### CITATION LIST

### Patent Literature

Patent Literature 1: JP 2006-302671 A

### SUMMARY OF INVENTION

### Technical Problem

However, even when the lithium iron phosphate particles produced by the method of Patent Literature 1 is used as a positive electrode active material, there is a problem that the rate property and discharge capacity are insufficient for use in applications for electrical power storage.

Therefore, the present invention is aimed at providing a positive electrode active material that provides higher rate property and discharge capacity, and a positive electrode and a non-aqueous electrolyte secondary battery using the positive electrode active material.

### Solution to Problem

In order to solve the above-mentioned problem, the present inventors did intensive studies, and consequently found that an lithium iron phosphate compound having specific diffraction peak intensities in a powder X-ray diffractometry has excellent rate property and discharge capacity, and completed the present invention. That is, the positive electrode active material of the present invention contains an lithium iron phosphate compound which has such diffraction peaks that diffraction peak intensity ratios at 2θ=17.2±0.5°, 2θ=20.8±0.5° and 2θ=25.6±0.5° are from 29 to 37, from 70 to 80 and from 85 to 94, respectively, when the diffraction peak intensity at 2θ=35.6±0.5° is deemed as 100, in a powder X-ray diffractometry using Cu-Kα ray as a radiation source.

Furthermore, a positive electrode of the present invention contains at least the above-mentioned positive electrode active material, an electroconductive material and a binder.

Furthermore, a non-aqueous electrolyte secondary battery of the present invention has a positive electrode which contains the above-mentioned positive electrode active material, a negative electrode, an electrolyte and a separator.

### Advantageous Effects of Invention

According to the present invention, a positive electrode active material, a positive electrode and a non-aqueous electrolyte secondary battery which have electroconductivity and provide higher rate property and discharge capacity can be provided.

### BRIEF DESCRIPTION OF DRAWINGS

FIG. 1A is an X-ray diffraction diagram of the positive electrode active material of Example 1.

FIG. 1B is an X-ray diffraction diagram of the positive electrode active material of Comparative Example 1.

FIG. 2 is an X-ray diffraction diagram of the positive electrode active material of Example 2.

FIG. 3 is an X-ray diffraction diagram of the positive electrode active material of Example 3.

FIG. 4 is an X-ray diffraction diagram of the positive electrode active material of Example 4.

FIG. 5 is an X-ray diffraction diagram of the positive electrode active material of Example 5.

### DESCRIPTION OF EMBODIMENTS

The embodiment of the present invention will be explained below.

### (Positive Electrode Active Material)

The positive electrode active material of the present invention contains an lithium iron phosphate compound that can be represented by the following formula (1):

LiₐFe_{1-b}M_{b}P_{1-c}X_{c}O₄ (1)

wherein M is at least one kind of element selected from the group consisting of Zr, Sn and Y. By substituting a part of M with the above-mentioned element, the change in the volume of the lithium iron phosphate compound which occurs during repeating of charging and discharging (insertion and detachment of lithium) can be suppressed. Especially, by selecting Zr, the change in the volume can further be suppressed. Meanwhile, although Fe and Zr may have various numbers of valence, the numbers of valence for providing the b in the general formula (1) mean average values.

Furthermore, X is at least one kind of element selected from Si and Al. By substituting a part of P with the above-mentioned element, the change in the volume of the lithium iron phosphate compound which generates during repeating of charging and discharging can be suppressed. Specifically, by selecting Si, the change in the volume can further be suppressed.

The b in the general formula (1) is 0≦b<1, and c is 0≦c<1. From the viewpoint of further decreasing the volume change rate of the lithium-containing composite metal oxide associated with the insertion and detachment of lithium, it is preferable that b is 0.05≦b<1 and c is 0.05≦c<1, it is more preferable that b is 0.05≦b≦0.25 and/or c is 0.10≦c≦0.50, and it is further preferable that b is 0.075≦b≦0.25 and/or c is 0.15≦c≦0.5. Meanwhile, in the case when the value of b is large (the amount of the substituted M element at the Fe site is much) and/or the value of c is large (the amount of the substituted X element at the P site is much), the volume change rate tends to be small and the discharge capacity tends to be small. Therefore, the values of b and c can be determined so as to increase the discharge capacity for the selected M.

Furthermore, a can have a numerical value in the range of 0<a<1 depending on the state of charging and discharging.

The positive electrode active material of the present invention has such diffraction peaks that diffraction peak intensity ratios at 2θ=17.2±0.5°, 2θ=20.8±0.5° and 2θ=25.6±0.5° are from 29 to 37, from 70 to 80 and from 85 to 94, respectively, when the diffraction peak intensity at 2θ=35.6±0.5° is deemed as 100 in a powder X-ray diffractometry using Cu-Kα ray as a radiation source. The diffraction peak intensity ratios at 2θ=17.2±0.5°, 2θ=20.8±0.5° and 2θ=25.6±0.5° are preferably 29 to 35, 70 to 71 and 85 to 91, respectively, and further preferably 29 to 31, 70.5 to 70.7 and 85 to 91, respectively. Within these ranges, the positive electrode active material has high rate property and discharge capacity.

Furthermore, it is preferable that diffraction peak intensity ratio at 2θ=29.7±0.5° is from 85 to 94. The reason is considered to be that the lithium diffusibility inside of the active material is improved by orientating the crystal structure to the (211+202) plane direction of the olivine structure that attributes to 2θ=29.7±0.5°.

Furthermore, it is preferable that the half width of the diffraction peak at 2θ=29.7±0.5° is from 0.31 to 0.48. It is generally known that a half width reflects a size of a crystallite, and in the case when the half width is more than 0.48 (i.e., in the case when the particle diameter is large), it is considered that the rate property is deteriorated since the lithium diffusion distance in the active material particles increases, and in the case when the half width is lower than 0.31 (i.e., in the case when the particle diameter is small), it is considered that an olivine structure that is suitable for the insertion and detachment of lithium is insufficient, and thus the discharge capacity decreases.

Furthermore, it is preferable that the half width of the diffraction peak at 2θ=35.6±0.5° is from 0.35 to 0.46.

Furthermore, it is preferable that, when the diffraction peak intensities at 2θ=25.6±0.5° and 2θ=29.7±0.5° are deemed as α and β, β/α is within the range from 0.870 to 0.895. In the case when the above-mentioned peak intensity ratio (β/α) is close to 1, the crystalline structure has little distortion and either of the Li elements has equal bonding energy against the adjacent elements, and thus it is considered that there is no Li conduct path where Li ions are specifically conducted. In the case when the above-mentioned peak intensity ratio (β/α) is from 0.870 to 0.895, the crystalline structure distorts against a specific plane, and a conduct path in which Li is preferentially and easily diffused is formed, and thus high capacity and rate property can be obtained. It is considered that, when the above-mentioned peak intensity ratio (β/α) is less than 0.870, further distortion generates in the crystal structure, and thus a Li ion path is not ensured sufficiently.

As a specific example of the lithium iron phosphate compound used in the present invention, for example, an lithium iron phosphate compound represented by the following formula can be used.

LiₐFe₁₋ₓMₓP_{l-y}Si_{y}O₄ (2)

As specific examples of the above-mentioned composition ratios a, x and y, those represented in the following Table 1 can be used.

TABLE 1

| | a | x | y |
|---|---|---|---|
| Composition | 1 | 0 | 0 |
| ratio 1 | | | |
| Composition | 1 | 0.01 | 0.02 |
| ratio 2 | | | |
| Composition | 1 | 0.025 | 0.05 |
| ratio 3 | | | |
| Composition | 1 | 0.0375 | 0.075 |
| ratio 4 | | | |
| Composition | 1 | 0.05 | 0.10 |
| ratio 5 | | | |
| Composition | 0.95 | 0.05 | 0.05 |
| ratio 6 | | | |
| Composition | 0.9625 | 0.0375 | 0.0375 |
| ratio 7 | | | |
| Composition | 0.975 | 0.025 | 0.025 |
| ratio 8 | | | |

### (Method for Producing Positive Electrode Active Material)

The method for producing the lithium iron phosphate compound having the above-mentioned general formula (1) includes at least a step of mixing a lithium source, an iron source and a phosphorus source, and the above-mentioned M element and/or X element as necessary, which become raw material substances, in a solid phase state (hereinafter referred to as a mixing step), a step of mixing the obtained mixed powder with a substance that becomes a carbon source (hereinafter referred to as a carbon source mixing step), and a step of calcinating the obtained carbon source-containing mixed powder (hereinafter a calcination step). According to this method, an lithium iron phosphate compound having electroconductivity can be produced by a single calcination, and thus a thermal process of two stages of calcination and thermal CVD as in Patent Literature 1 becomes unnecessary, and the production cost can be decreased. Meanwhile, for selecting the lithium source, iron source, phosphorus source, M element and/or X element which become raw material substances, as mentioned above, it is necessary to select raw materials that give an lithium iron phosphate compound having diffraction peak intensity ratios at 2θ=17.2±0.5°, 2θ=20.8±0.5° and 2θ=25.6±0.5° of from 29 to 37, from 70 to 80 and from 85 to 94, respectively.

### (Lithium Source)

For the substance that becomes a lithium source, inorganic salts, hydroxides, organic acid salts and metal alkoxides of lithium, and hydrates of these salts can be used. Specifically, the inorganic salts can include lithium carbonate (Li₂CO₃), which is a salt with a weak acid (hereinafter referred to as a weak acid salt), lithium nitrate (LiNO₃), which is a salt with a strong acid (hereinafter referred to as a strong acid salt), and lithium chloride (LiCl). Furthermore, as the organic salts, lithium acetate (CH₃COOLi) and lithium oxalate (COOLi)₂, which are weak acid salts, can be exemplified. Furthermore, as the metal alkoxides, lithium methoxide (LiOCH₃), lithium ethoxide (LiOC₂H₅), lithium-n-propoxide (LiO-n-C₃H₇), lithium-i-propoxide (LiO-i-C₃H₇), lithium-n-butoxide (LiO-n-C₄H₉), lithium-t-butoxide (LiO-t-C₄H₉), lithium-sec-butoxide (LiO-sec-C₄H₉) and the like can be exemplified. The inorganic salts and organic salts may also be hydrates. Lithium acetate or lithium nitrate is preferable.

### (Iron Source)

As the substance that becomes an iron source, inorganic salts, hydroxides, organic acid salts and metal alkoxides of iron, and hydrates of these salts can be used. As the iron source, inorganic salts such as iron(II) carbonate (Fe(CO₃)), which is a weak acid salt, and iron(II) nitrate (Fe(NO₃)₂), iron(III) nitrate (Fe(NO₃)₃), iron(II) chloride (FeCl₂) and iron(III) chloride (FeCl₃), which are strong acid salts, can be exemplified. Furthermore, as the organic salts, iron(II) oxalate (FeC₂O₄), iron(III) oxalate (Fe₂(C₂O₄)₃), iron(II) acetate (Fe(CH₃COO)₂) and iron(III) acetate (Fe(CH₃COO)₃), which are weak acid salts, can be exemplified. Among these, hydrate of iron(II) oxalate (FeC₂O₄) is preferable.

### (Zirconium Source)

For the substance that becomes a zirconium source, inorganic salts, organic acid salts and metal alkoxides of zirconium, and hydrates of these salts can be used. As the zirconium source, inorganic salts such as zirconium chloride (ZrCl₄), zirconium bromide (ZrBr₄) and zirconium iodide (ZrI₄), which are zirconium halides, and oxyzirconium chloride (ZrOCl₂) and oxyzirconium nitrate (ZrO(NO₃)₂), which are oxyzirconium salts, can be exemplified. Furthermore, as the organic acid salts, ZrO(CH₃CO₂)₂ can be exemplified, and as the metal alkoxide, zirconium methoxide (Zr(OCH₃)₄), zirconium ethoxide (Zr(OC₂H₅)₄), zirconium-n-propoxide (Zr(O-n-C₃H₇)₄), zirconium-i-propoxide (Zr(O-i-C₃H₇)₄), zirconium-n-butoxide (Zr(O-n-C₄H₈)₄), zirconium-t-butoxide (Zr(O-t-C₄H₈)₄), zirconium-sec-butoxide (Zr(O-t-C₄H₈)₄) and the like can be exemplified. Preferably, zirconium halides, of which zirconium chloride is preferable.

### (Phosphorus Source)

As the substance that becomes a phosphorus source, phosphoric acid (H₃PO₄), ammonium hydrogen phosphate ((NH₄)₂HPO₄), ammonium dihydrogen phosphate (NH₄H₂PO₄) and the like can be exemplified. Among these, ammonium hydrogen phosphate is preferable.

### (Silicon Source)

As the substance that becomes a silicon source, metal alkoxides of silicon can be used. Specific examples can include various silicon alkoxides such as tetraethoxysilane (Si(OC₂H₅)₄), tetramethoxysilane (Si(OCH₃)₄), methyltriethoxysilane (CH₃Si(OC₂H₅)₃), methyltrimethoxysilane (CH₃Si(OCH₃)₃), ethylmethoxysilane (C₂H₅Si(OCH₃)₃) and ethyltriethoxysilane (C₂H₅Si(OC₂H₅)₃) can be exemplified. Alternatively, SiO₂, which is a calcined product of a metal alkoxide, can be used. Among these, tetraethoxysilane or tetramethoxysilane is preferable.

The mixing method is dry mixing, and examples can include, but are limited to, a planetary ball mill, a ball mill, a bead mill, an oscillation mill, a pin mill, an atomizer, a homogenizer, a rotor mill, a roller mill, a hammer mill, a jet mill and the like. Furthermore, where necessary, warming, cooling and atmosphere controlling can also be conducted. The average particle size of the mixed powder is from 0.01 to 10.0 μm, preferably from 0.1 to 1.0 μm.

As carbon source used in the carbon source mixing step, sugars, fats and synthetic resin materials can be exemplified. As the sugars, sucrose, fructose and the like can be used. Furthermore, as the synthetic resin materials, polyethers such as polyethylene glycol and polypropylene glycol, polyvinyl alcohol, polyacrylamide, carboxymethyl cellulose, polyvinyl acetate and the like can be used. Sugars are preferable, of which sucrose is preferable. The amount of the carbon source is 0.1 to 10 parts by weight, preferably 1 to 5 parts by weight with respect to 100 parts by weight of the starting raw materials of the lithium iron phosphate compound. In the case when the amount is less than 0.1 part by weight, the electroconductivity of the lithium iron phosphate compound is insufficient, whereas when the amount is more than 10 parts by weight, the insertion and detachment of lithium ions are inhibited and thus the capacity decreases.

The calcination step is conducted at a temperature range from 400 to 700° C. over 1 to 24 hours. As the atmosphere during the calcination, inert atmospheres (atmospheres such as argon, nitrogen and vacuum) or reductive atmospheres (atmospheres such as hydrogen-containing inert gas and carbon monoxide) can be used. In order to conduct the calcination homogeneously, a mixed powder may be stirred, and in the case when a toxic gas such as NOₓ, SOₓ, chlorine or the like generates during the calcination, a removing apparatus may also be disposed.

Furthermore, where necessary, the obtained lithium iron phosphate may be prepared into a desired particle size by subjecting to a pulverizing step and/or a classification step.

### (Method for Producing Positive Electrode)

The positive electrode can be prepared by using a known method. For example, the positive electrode can be prepared by kneading dispersion of a positive electrode active material, an electroconductive material and a binder by using an organic solvent to give a paste, and applying the paste onto a current collector. In the case when the obtained lithium-containing composite oxide has a sufficiently high electroconductivity, it is not always necessary to add the electroconductive material.

As the binder, polytetrafluoroethylene, polyvinylidene fluoride, polyvinyl chloride, ethylene propylene diene polymers, styrene-butadiene rubbers, acrylonitrile-butadiene rubbers, fluorine rubbers, polyvinyl acetate, polymethyl methacrylate, polyethylene, nitrocellulose, styrene-butadiene rubbers and the like can be used. Where necessary, a thickener material such as carboxymethyl cellulose can also be used.

As the electroconductive material, acetylene black, natural graphite, artificial graphite, needle coke and the like can be used.

As the current collector, foamed (porous) metals having continuous pores, metals formed into a honeycomb shape, sintered metals, expanded metals, nonwoven fabrics, boards, boards with open pores, foils and the like can be used.

As the organic solvent, N-methyl-2-pyrrolidone, toluene, cyclohexane, dimethylformamide, dimethylacetamide, methyl ethyl ketone, methyl acetate, methyl acrylate, diethyltriamine, N,N-dimethylaminopropylamine, ethylene oxide, tetrahydrofuran and the like can be used. In the case when a water-soluble binder is used as the binder, water can also be used as the solvent.

The thickness of the positive electrode is preferably about from 0.01 to 20 mm. If the thickness is too thick, it is not preferable since the electroconductivity decreases, whereas if the thickness is too thin, it is not preferable since the capacity per a unit surface area decreases. In addition, the positive electrode obtained by application and drying may be consolidated by roller press or the like so as to increase the filling density of the active material.

Furthermore, the amount of the positive electrode active material that is present per a unit surface area of the current collector is 30 mg/cm² or more, preferably from 30 mg/cm² to 60 mg/cm². If the amount is less than 30 mg/cm², it is not preferable since cracking easily occurs.

The other constitutional materials of the battery will be explained below.

### (Negative Electrode)

The negative electrode can be prepared by a known method. For example, the negative electrode can be prepared by mixing a negative electrode active material, a binder and an electroconductive material, molding the obtained mixed powder into a sheet-like form, and attaching the obtained formed article to a current collector such as a mesh-like current collector made of stainless or copper by applying a pressure. Furthermore, the negative electrode can be prepared by using an aqueous slurry in a similar manner to that in the case of the positive electrode, and in such case, the negative electrode can be prepared by kneading dispersion of at least a negative electrode active material, an electroconductive material and a binder by using water to give a slurry, and applying the slurry onto a current collector. Where necessary, an electroconductive material may also be added.

As the negative electrode active material, a known material can be used. In order to constitute a high energy density battery, a material having a potential for the insertion/detachment of lithium which is close to the potential for the precipitation/dissolution of metallic lithium is preferable. Typical examples thereof are carbon materials such as particulate (scale-like, massive, fibrous, whisker-like, globular, pulverized particulate or the like) natural or artificial graphites.

Examples of the artificial graphites can include graphites obtained by graphitizing mesocarbon microbeads, mesophase pitch powders, isotropic pitch powders and the like. Furthermore, graphite particles with amorphous carbon attached to the surfaces thereof can also be used. Among these, natural graphites are preferable since they are inexpensive and having oxidation/reduction potentials that are close to those of lithium, and thus a high-energy density battery can be constituted.

Furthermore, lithium transition metal oxides, lithium transition metal nitrides, transition metal oxides, silicon oxides and the like can also be used as the negative electrode active material. Among these, Li₄Ti₅O₁₂ is preferable since the flatness of the potential is high, and the change in the volume due to charging and discharging is small.

### (Non-Aqueous Electrolyte)

As the non-aqueous electrolyte, for example, organic electrolyte liquids, gel-like electrolytes, polymer solid electrolytes, inorganic solid electrolytes, molten salts and the like can be used.

As the organic solvents for constituting the organic electrolyte liquids, cyclic carbonates such as propylene carbonate (PC), ethylene carbonate (EC) and butylene carbonate, chain carbonates such as dimethyl carbonate (DMC), diethyl carbonate (DEC), ethyl methyl carbonate and dipropyl carbonate, lactones such as γ-butyrolactone (GBL) and γ-valerolactone, furans such as tetrahydrofuran and 2-methyltetrahydrofuran, ethers such as diethyl ether, 1,2-dimethoxyethane, 1,2-diethoxyethane, ethoxymethoxyethane and dioxane, dimethylsulfoxide, sulforane, methylsulforane, acetonitrile, methyl formate, methyl acetate and the like can be exemplified, and one kind or a mixture of two or more kinds from these can be used.

Furthermore, since cyclic carbonates such as PC, EC and butylene carbonate are high-boiling point solvents, they are preferable as solvents to be mixed with GBL.

As the electrolyte salts for constituting the organic electrolyte liquids, lithium salts such as lithium borofluoride (LiBF₄), lithium hexafluorophosphate (LiPF₆), lithium trifluoromethanesulfonate (LiCF₃SO₃), lithium trifluoroacetate (LiCF₃COO) and lithium bis(trifluoromethanesulfone)imide (LiN(CF₃SO₂)₂) can be exemplified, and one or more kinds of these can be mixed and used. The salt concentration in the electrolyte liquid is preferably from 0.5 to 3 mol/L.

### (Separator)

As the separator, known materials such as porous materials and nonwoven fabrics can be used. As the material for the separator, a material that does not dissolve or swell in the organic solvent in the electrolyte liquid is preferable. Specific examples include polyester-based polymers, polyolefin-based polymers (for example, polyethylene, polypropylene), ether-based polymers, glass fibers and the like can be exemplified.

### (Other Elements)

Known various materials can be used also for other elements such as a battery container, and the materials are not especially limited.

### (Method for Producing Secondary Battery)

The secondary battery has, for example, a stacked body including a positive electrode and a negative electrode, and a separator that is sandwiched therebetween. The stacked body may have, for example, a reed-like planar shape. Furthermore, in the case when a cylindrical or planular battery is prepared, the stacked body may be wound to form a wound body.

One or plural stacked body (bodies) is/are inserted into a battery container. Generally, the positive electrode and negative electrode are connected to outer electroconductive terminals of the battery. The battery container is then sealed so as to block the positive electrode, negative electrode and separator from ambient air.

The method for sealing is, in the case of a cylindrical battery, generally a method including fitting a lid having a packing made of a resin in an opening of a battery container to thereby caulk the gap between the container and lid. Furthermore, in the case of a square-shaped battery, a method including attaching a lid called as a sealing plate made of a metal to the opening, and conducting welding can be used. Besides these methods, a method including sealing by a binder, and a method including fixing with a bolt through a gasket can also be used. Furthermore, a method including sealing with a laminate film including a metal foil and a thermoplastic resin attached thereto can also be used. In addition, an opening for injecting an electrolyte during sealing may be disposed. In the case when an organic electrolyte liquid is used, the organic electrolyte liquid is injected from that opening, and the opening is then sealed. The generated gas may be removed by energization before the sealing.

### EXAMPLES

The present invention will further be explained in more detail by using Examples, but the present invention is not limited by the following Examples.

### Example 1

### (Synthesis of Positive Electrode Active Material)

Lithium acetate as a Li source was set to 0.4 g, and FeC₂O₄.2H₂O as an iron source and (NH₄)₂HPO₄ as a phosphorus source were respectively weighed so as to give a molar ratio of Li:Fe:P=1:1:1, whereby starting raw materials were prepared. The starting raw materials and zirconia balls each having a diameter of 10 mm were put into a zirconia pot and mixed by using a ball mill apparatus (manufactured by Gokin Planetaring Inc.) at a rotation number of 400 rpm for 1 hour. Sucrose dissolved in water was added so that the solid content of the obtained starting raw materials with respect to the mixed powder became 53% by weight, and the mixture was dried and mixed in a mortar. The obtained precursor was calcined under a nitrogen atmosphere at 550° C. for 12 hours to give a positive electrode active material.

### (Result)

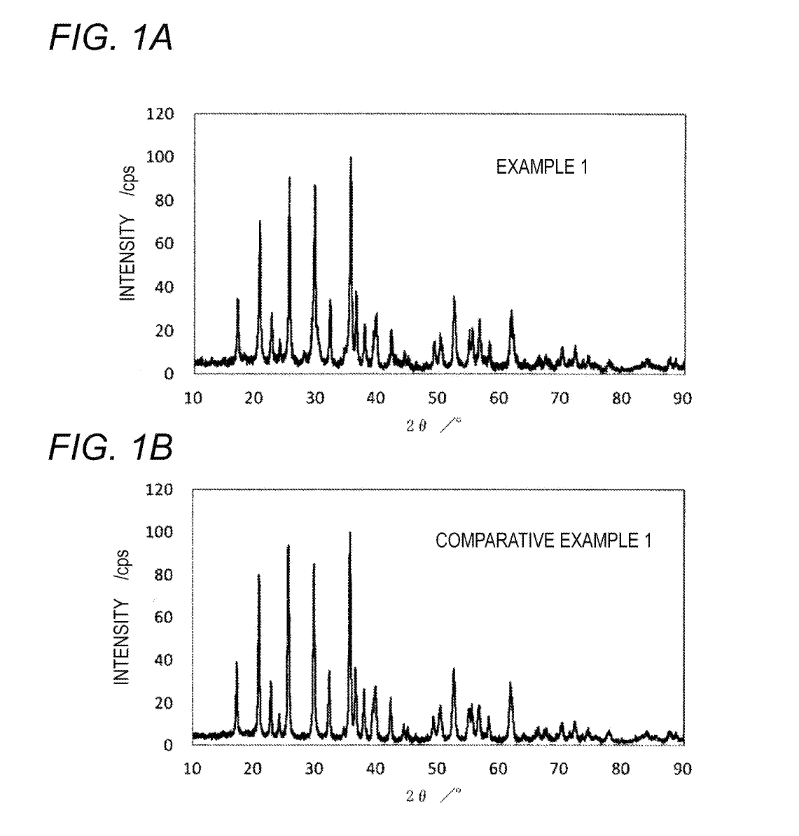

A powder X-ray diffractometry was conducted on the obtained positive electrode active material by using a powder X-ray diffraction apparatus MiniFlex II manufactured by Rigaku Corporation. The result is shown in FIG. 1A. That the peaks attributed to the raw material substances and impurities such as ZrO₂ were absent was confirmed. The intensities, intensity ratios and half widths of the diffraction peaks are shown in Table 2.

### (Evaluation of Secondary Battery Property)

A secondary battery was prepared by the following method using the obtained positive electrode active material.

The obtained positive electrode active material was pulverized by an agate mortar. About 80% by weight of the obtained pulverized product, about 10% by weight of acetylene black (Denka Black manufactured by Denki Kagaku Kogyo Kabushiki Kaisha) as an electroconductive material, and about 10% by weight of a polytetrafluoroethylene powder (Kureha KF Polymer manufactured by Kureha Corporation) as a binder were mixed.

The mixture was dissolved and dispersed in N-methyl-2-pyrrolidone (manufactured by Kishida Chemical Co., Ltd.) to put the mixture into a slurry form, and this was applied onto both surfaces of an aluminum foil having a thickness of 20 μm by a doctor blade process. The amount of application was adjusted to be about 5 mg/cm². The coating was dried, cut so as to give an electrode application surface of 2 cm×2 cm, and pressed, whereby a positive electrode (total thickness: 30 μm) was prepared.

As a negative electrode active material, a natural graphite powder (MAG, a negative electrode material for a lithium ion battery manufactured by Hitachi Chemical Company, Ltd.) was used. About 10% by weight of a Teflon resin powder was mixed as a binder with this negative electrode active material. This mixture was dissolved and dispersed in N-methyl-2-pyrrolidone to put the mixture into a slurry form, and this was applied onto both surfaces of a copper foil having a thickness of 20 μm, dried and pressed, whereby a negative electrode (total thickness: 30 μm) was prepared.

The positive electrode and negative electrode prepared as above were each cut into a size of 30 mm×30 mm, and a tab made of aluminum having a width of 3 mm and a length of 50 mm was welded on the positive electrode and a tab made of copper having a width of 3 mm and a length of 50 mm was welded on the negative electrode as terminals for introducing an electrical current of the secondary battery, whereby the positive electrode and negative electrode were prepared.

A separator of a fine pore film made of a polyolefin-based resin (Hipore manufactured by Asahi Kasei Corporation) was sandwiched between these positive electrode and negative electrode. The obtained stacked body was sandwiched between laminate films as an outer covering of the battery, which included two metal foils having thermoplastic resins attached thereto, and the circumference except for the opening for injecting an electrolyte was subjected to thermal welding to seal the outer covering of the battery.

An electrolyte in which 50% by volume of ethylene carbonate and 50% by volume of diethyl carbonate had been dissolved in 1 mol/l of LiPF₆ was introduced from the opening to the outer covering of the battery, whereby the stacked body was impregnated with the electrolyte.

The opening was sealed after the impregnation, whereby a secondary battery was obtained.

The battery prepared in such way was charged and discharged under an environment of 25° C. The capacity of the battery was obtained by conducting charging at a 0.1 C constant electrical current up to 3.6 V and discharging at a 0.1 C constant electrical current up to 2 V (hereinafter referred to as a 0.1 C capacity). The rate property was defined by [(1.0 C capacity/0.1 C capacity)×100(%)]. The 1.0 C capacity was obtained by conducting charging at a 0.1 C constant electrical current up to 3.6 V, and discharging at a 1.0 C constant electrical current up to 2 V. The result is shown in Table 3.

### Example 2

### (Synthesis of Positive Electrode Active Material)

A positive electrode active material was synthesized according to a similar method to that of Example 1, except that zirconia balls each having a diameter of 1 mm were used in the ball mill mixing.

### (Result)

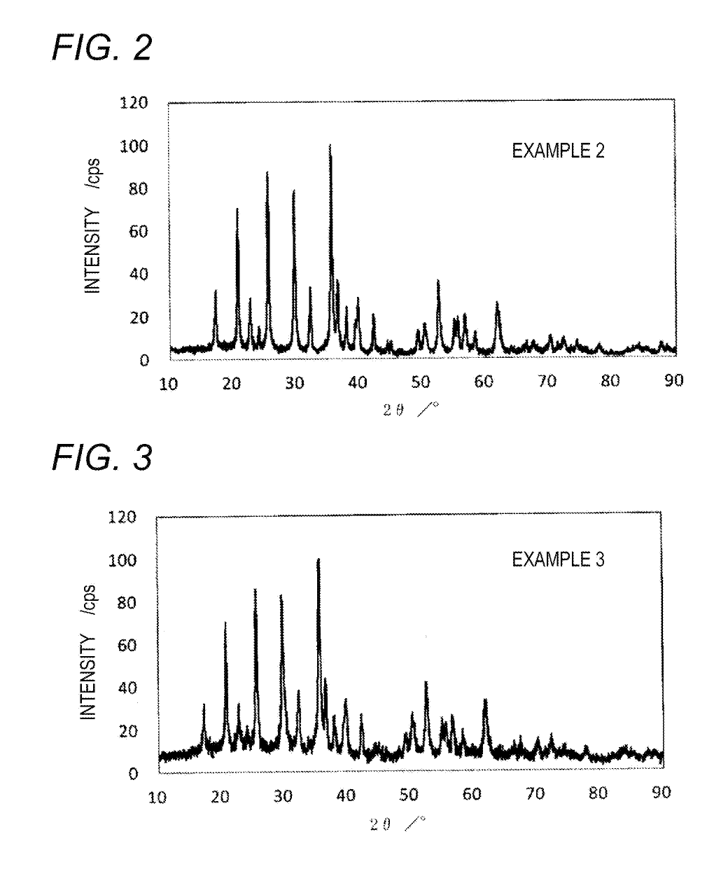

A powder X-ray diffractometry was conducted on the obtained positive electrode active material by using a powder X-ray diffraction apparatus MiniFlex II manufactured by Rigaku Corporation. The result is shown in FIG. 2. That the peaks attributed to the raw material substances and impurities such as ZrO₂ were absent was confirmed. The intensities, intensity ratios and half widths of the diffraction peaks are shown in Table 2.

Furthermore, a secondary battery was prepared by using a similar method to that in the case of Example 1, and the rate property thereof was measured. The result is shown in Table 3.

### Example 3

### (Synthesis of Positive Electrode Active Material)

Lithium acetate as a Li source was set to 0.4 g, and FeC₂O₄.2H₂O as an iron source, (NH₄)₂HPO₄ as a phosphorus source, ZrO(CH₃CO₂)₂ as a zirconium source, and SiO₂ as a silicon source were respectively weighed so as to give a molar ratio of Li:Fe:Zr:P:Si=1:0.95:0.05:0.9:0.1, whereby starting raw materials were prepared. The starting raw materials and zirconia balls each having a diameter of 10 mm were put into a zirconia pot and mixed by using a ball mill apparatus (manufactured by Gokin Planetaring Inc.) at a rotation number of 400 rpm for 1 hour. Sucrose dissolved in water was added so that the solid content of the obtained starting raw materials with respect to the mixed powder became 53% by weight, and the mixture was dried and mixed in a mortar. The obtained precursor was calcined under a nitrogen atmosphere at 550° C. for 12 hours to give a positive electrode active material.

### (Result)

A powder X-ray diffractometry was conducted on the obtained positive electrode active material by using a powder X-ray diffraction apparatus MiniFlex II manufactured by Rigaku Corporation. The result is shown in FIG. 3. That the peaks attributed to the raw material substances and impurities such as Zr02 were absent was confirmed. The intensities, intensity ratios and half widths of the diffraction peaks are shown in Table 2.

Furthermore, a secondary battery was prepared by using a similar method to that in the case of Example 1, and the rate property thereof was measured. The result is shown in Table 3.

### Example 4

A positive electrode active material was synthesized according to a similar method to that of Example 3, except that zirconia balls each having a diameter of 1 mm were used in the ball mill mixing.

### (Result)

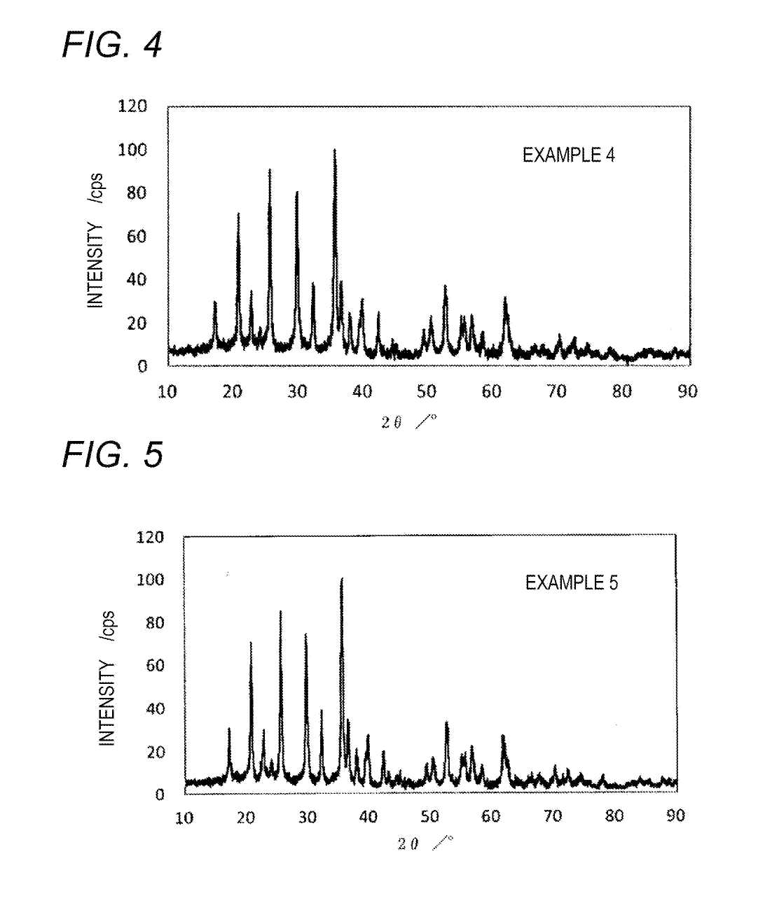

A powder X-ray diffractometry was conducted on the obtained positive electrode active material by using a powder X-ray diffraction apparatus MiniFlex II manufactured by Rigaku Corporation. The result is shown in FIG. 4. That the peaks attributed to the raw material substances and impurities such as ZrO₂ were absent was confirmed. The intensities, intensity ratios and half widths of the diffraction peaks are shown in Table 2.

Furthermore, a secondary battery was prepared by using a similar method to that in the case of Example 1, and the rate property thereof was measured. The result is shown in Table 3.

### Example 5

### (Synthesis of Positive Electrode Active Material)

Lithium acetate as a Li source was set to 0.4 g, and FeC₂O₄.2H₂O as an iron source, (NH₄)₂HPO₄ as a phosphorus source, ZrO(CH₃CO₂)₂ as a zirconium source, and SiO₂ as a silicon source were respectively weighed so as to give a molar ratio of Li:Fe:Zr:P:Si=1:0.95:0.05:0.9:0.1, whereby starting raw materials were prepared. The starting raw materials and zirconia balls each having a diameter of 10 mm were put into a zirconia pot and mixed by using a ball mill apparatus (manufactured by Gokin Planetaring Inc.) at a rotation number of 400 rpm for 1 hour. Sucrose dissolved in water was added so that the solid content of the obtained starting raw materials with respect to the mixed powder became 53% by weight, and the mixture was dried and mixed in a mortar. The obtained precursor was calcined under a nitrogen atmosphere at 550° C. for 12 hours to give a positive electrode active material. 10 parts by weight of acetylene black (manufactured by Denki Kagaku Kogyo Kabushiki Kaisha) was mixed with 100 parts by weight of the obtained positive electrode active material, and the mixture was mixed by using a ball mill apparatus (manufactured by Gokin Planetaring Inc.) at 400 rpm for 1 hour, whereby a positive electrode active material in which acetylene black was carried on the surface was obtained.

### (Result)

A powder X-ray diffractometry was conducted on the obtained positive electrode active material by using a powder X-ray diffraction apparatus MiniFlex II manufactured by Rigaku Corporation. The result is shown in FIG. 5. That the peaks attributed to the raw material substances and impurities such as ZrO₂ were absent was confirmed. The intensities, intensity ratios and half widths of the diffraction peaks are shown in Table 2.

Furthermore, a secondary battery was prepared by using a similar method to that in the case of Example 1, and the rate property thereof was measured. The result is shown in Table 3.

### Comparative Example 1

### (Synthesis of Positive Electrode Active Material)

Lithium acetate as a Li source was set to 0.4 g, and FeC₂O₄.2H₂O as an iron source and (NH₄)₂HPO₄ as a phosphorus source were respectively weighed so as to give a molar ratio of Li:Fe:P=1:1:1, whereby starting raw materials were prepared. The starting raw materials and zirconia balls each having a diameter of 10 mm were put into a zirconia pot and mixed by using a ball mill apparatus (manufactured by Gokin Planetaring Inc.) at a rotation number of 400 rpm for 1 hour. The obtained mixed powder of starting raw materials was calcined under a nitrogen atmosphere at 550° C. for 12 hours to give a calcined powder. Sucrose dissolved in water was added so that the solid content of the obtained starting raw materials with respect to the calcined powder became 53% by weight, and the mixture was dried and mixed in a mortar. The obtained mixed powder was calcined under a nitrogen atmosphere at 550° C. for 12 hours to give a positive electrode active material.

### (Result)

A powder X-ray diffractometry was conducted on the obtained positive electrode active material by using a powder X-ray diffraction apparatus MiniFlex II manufactured by Rigaku Corporation. The result is shown in FIG. 1B. That the peaks attributed to the raw material substances and impurities such as ZrO₂ were absent was confirmed. The intensities, intensity ratios and half widths of the diffraction peaks are shown in Table 2.

Furthermore, a secondary battery was prepared by using a similar method to that in the case of Example 1, and the rate property thereof was measured. The result is shown in Table 3.

### Reference Example 1

A positive electrode active material was synthesized according to a similar method to that of Example 1, except that Li₂CO₃, Fe₃O₄ and (NH₄)H₂PO₄ were used as starting raw materials.

### (Result)

A powder X-ray diffractometry was conducted on the obtained positive electrode active material by using a powder X-ray diffraction apparatus MiniFlex II manufactured by Rigaku Corporation. That the peaks attributed to the raw material substances and impurities such as ZrO₂ were absent was confirmed. The intensities, intensity ratios and half widths of the diffraction peaks are shown in Table 2.

Furthermore, a secondary battery was prepared by using a similar method to that in the case of Example 1, and the rate property thereof was measured. The result is shown in Table 3.

### Reference Example 2

A positive electrode active material was synthesized according to a similar method to that of Example 1, except that Li₂CO₃, FeC₂O₄.2H₂O and (NH₄)H₂PO₄ were used as the starting raw materials.

### (Result)

A powder X-ray diffractometry was conducted on the obtained positive electrode active material by using a powder X-ray diffraction apparatus MiniFlex II manufactured by Rigaku Corporation. That the peaks attributed to the raw material substances and impurities such as ZrO₂ were absent was confirmed. The intensities, intensity ratios and half widths of the diffraction peaks are shown in Table 2.

Furthermore, a secondary battery was prepared by using a similar method to that in the case of Example 1, and the rate property thereof was measured. The result is shown in Table 3.

TABLE 2

| | | | | Comparative | | | | | Reference | Reference |
|---|---|---|---|---|---|---|---|---|---|---|
| | | | Example 1 | Example 1 | Example 2 | Example 3 | Example 4 | Example 5 | Example 1 | Example 2 |
| (200) | Around | Intensity | 278 | 400 | 288 | 205 | 213 | 263 | 383 | 371 |
| | 17.2° | Intensity | 34.84 | 38.95 | 32.18 | 32.18 | 29.50 | 30.69 | 37.85 | 37.62 |
| | | ratio | | | | | | | | |
| | | Half | 0.30 | 0.30 | 0.38 | 0.46 | 0.44 | 0.34 | 0.32 | 0.30 |
| | | width | | | | | | | | |
| (101) | Around | Intensity | 563 | 825 | 630 | 448 | 510 | 605 | 811 | 803 |
| | 20.8° | Intensity | 70.55 | 80.33 | 70.39 | 70.33 | 70.64 | 70.60 | 80.13 | 81.32 |
| | | ratio | | | | | | | | |
| | | Half | 0.34 | 0.28 | 0.30 | 0.38 | 0.32 | 0.28 | 0.28 | 0.31 |
| | | width | | | | | | | | |
| (210) | Around | Intensity | 227 | 310 | 255 | 205 | 252 | 257 | 289 | 292 |
| | 22.7° | Intensity | 28.45 | 30.19 | 28.49 | 32.18 | 34.90 | 29.99 | 28.54 | 29.55 |
| | | ratio | | | | | | | | |
| | | Half | 0.38 | 0.34 | 0.36 | 0.44 | 0.38 | 0.36 | 0.36 | 0.37 |
| | | width | | | | | | | | |
| (111 + 201) | Around | Intensity | 723 | 967 | 783 | 547 | 655 | 730 | 954 | 939 |
| | 25.6° | Intensity | 90.60 | 94.16 | 87.49 | 85.87 | 90.72 | 85.18 | 94.25 | 95.11 |
| | | ratio | | | | | | | | |
| | | Half | 0.30 | 0.34 | 0.30 | 0.38 | 0.34 | 0.30 | 0.34 | 0.33 |
| | | width | | | | | | | | |
| (211 + 020) | Around | Intensity | 698 | 878 | 705 | 528 | 580 | 637 | 878 | 861 |
| | 29.7° | Intensity | 87.47 | 85.55 | 78.78 | 82.89 | 80.33 | 74.33 | 86.75 | 87.25 |
| | | ratio | | | | | | | | |
| | | Half | 0.32 | 0.30 | 0.32 | 0.48 | 0.36 | 0.34 | 0.29 | 0.30 |
| | | width | | | | | | | | |
| (301) | Around | Intensity | 273 | 362 | 298 | 243 | 277 | 335 | 370 | 344 |
| | 32.2° | Intensity | 34.21 | 35.25 | 33.30 | 38.15 | 38.37 | 39.09 | 36.54 | 34.89 |
| | | ratio | | | | | | | | |
| | | Half | 0.28 | 0.34 | 0.34 | 0.52 | 0.38 | 0.30 | 0.33 | 0.35 |
| | | width | | | | | | | | |
| (311) | Around | Intensity | 798 | 1027 | 895 | 637 | 722 | 857 | 1012 | 987 |
| | 35.6° | Intensity | 100.00 | 100.00 | 100.00 | 100.00 | 100.00 | 100.00 | 100.00 | 100.00 |
| | | ratio | | | | | | | | |
| | | Half | 0.36 | 0.34 | 0.34 | 0.46 | 0.40 | 0.38 | 0.32 | 0.34 |
| | | width | | | | | | | | |
| (121) | Around | Intensity | 305 | 375 | 330 | 280 | 283 | 297 | 376 | 378 |
| | 36.5° | Intensity | 38.22 | 36.51 | 36.87 | 43.96 | 39.20 | 34.66 | 37.12 | 38.27 |
| | | ratio | | | | | | | | |
| | | Half | 0.30 | 0.38 | 0.36 | 0.54 | 0.40 | 0.42 | 0.39 | 0.37 |
| | | width | | | | | | | | |
| (410) | Around | Intensity | 183 | 275 | 220 | 168 | 177 | 178 | 263 | 255 |
| | 37.9° | Intensity | 22.93 | 26.78 | 24.58 | 26.37 | 24.52 | 20.77 | 25.98 | 25.88 |
| | | ratio | | | | | | | | |
| | | Half | 0.42 | 0.30 | 0.30 | 0.48 | 0.46 | 0.36 | 0.39 | 0.41 |
| | | width | | | | | | | | |
| β/α | | | 0.965 | 0.900 | 0.965 | 0.965 | 0.885 | 0.873 | 0.920 | 0.917 |

TABLE 3

| | | Comparative | | | | | | |
|---|---|---|---|---|---|---|---|---|
| | Example 1 | Example 1 | Example 2 | Example 3 | Example 4 | Example 5 | Reference Example 1 | Reference Example 1 |
| 0.1 C | 162.0 | 121.9 | 163.1 | 162.5 | 164.2 | 165.1 | 138.2 | 142.5 |
| capacity | | | | | | | | |
| (mAh/g) | | | | | | | | |
| 1 C | 150.8 | 98.7 | 157.1 | 157.8 | 161.2 | 163.1 | 52.8 | 78.3 |
| capacity | | | | | | | | |
| (mAh/g) | | | | | | | | |
| Rate | 93.1% | 81.0% | 96.3% | 97.1% | 98.2% | 98.8% | 38.2% | 54.9% |
| property | | | | | | | | |
| (1 C/0.1 C) | | | | | | | | |

As shown in Table 3, both the 0.1 C capacity and 1 C capacity of Comparative Example 1 were lower than those of Examples 1 to 5, and the rate property was 81%, which was a lower value than the values of Examples, which were more than 93%. In addition, Reference Examples 1 and 2 were the cases when the starting raw materials were different from those of Example 1, and had intensity ratios of the diffraction peaks as specified in the present invention of out of the scope of the present invention, and also had lower values of the 0.1 C capacity and 1 C capacity, and of the rate property than those of Example 1.

1. A positive electrode active material, which contains an lithium iron phosphate compound having such diffraction peaks that diffraction peak intensity ratios at 2θ=17.2±0.5°, 2θ=20.8±0.5° and 2θ=25.6±0.5° are from 29 to 37, from 70 to 80 and from 85 to 94, respectively, when the diffraction peak intensity at 2θ=35.6±0.5° is deemed as 100, in a powder X-ray diffractometry using Cu-Kα ray as a radiation source.

2. The positive electrode active material according to claim 1, which further has a diffraction peak intensity ratio at 2θ=29.7±0.5° of from 85 to 94.

3. The positive electrode active material according to claim 2, wherein the diffraction peak at 2θ=29.7±0.5° has a half width of from 0.31 to 0.48.

4. The positive electrode active material according to claim 1, wherein the diffraction peak at 2θ=35.6±0.5° has a half width of from 0.35 to 0.46.

5. The positive electrode active material according to claim 2, wherein when the diffraction peak intensities at 2θ=25.6±0.5° and 2θ=29.7±0.5° are deemed as α and β, β/α is within the range from 0.870 to 0.895.

6. A positive electrode containing at least the positive electrode active material according to claim 1, an electroconductive material and a binder.

7. A non-aqueous electrolyte secondary battery having a positive electrode containing the positive electrode active material according to claim 1, a negative electrode, an electrolyte and a separator.
